(19) United States
(12) Patent Application Publication
(10) Pub. No.: US 2020/0182632 A1
(43) Pub. Date: Jun. 11, 2020

(54) NAVIGATION SYSTEM AND ROUTE SEARCH METHOD THEREOF

(71) Applicants: HYUNDAI MOTOR COMPANY, Seoul (KR); KIA MOTORS CORPORATION, Seoul (KR)

(72) Inventor: Tae Hyun SUNG, Seoul (KR)

(21) Appl. No.: 16/397,111

(22) Filed: Apr. 29, 2019

(30) Foreign Application Priority Data
Dec. 6, 2018 (KR) 10-2018-0156416

(51) Int. Cl. G01C 21/34

(52) U.S. Cl. CPC G01C 21/34

(57) ABSTRACT

A navigation system includes: a communication device configured to perform data communication; a data collecting device configured to collect positioning data of vehicles through the communication device; and a processor configured to establish database including connection information between entry points and exit points for each spatial object based on the positioning data, and performs route search using the connection information when there is a route search request.

### CROSS-REFERENCE TO RELATED APPLICATION

This application is based on and claims the benefit of priority to Korean Patent Application No. 10-2018-0156416 filed in the Korean Intellectual Property Office on Dec. 6, 2018, the disclosure of which is incorporated herein in its entirety by reference.

### TECHNICAL FIELD

The present disclosure relates a navigation system and a route search method thereof.

### BACKGROUND

A navigation system searches for and suggests an optimal route in consideration of a distance from a current position to a destination and traffic situation. Such a navigation system does not have information on connection relationship between an entry point and an exit point in a spatial object, such as an underground parking lot. Therefore, a conventional navigation system hardly suggests an optimal route when an exit point is limited depending on an entry point of a spatial object. For example, in a case in which a vehicle cannot exit an underground parking lot through an exit gate “C” when the vehicle enters the underground parking lot through an entrance gate “A”, it is hard to provide guide information indicating that a vehicle cannot exit the parking lot through the exit gate “C” in the case of entry through the entrance gate “A”.

Conventionally, when there are a plurality of entry points or exit points in a departure place and/or a destination place, route search is performed based on an exit point communicated with the nearest road section (link) to the current position of a vehicle or any one of the plurality of entry points of the destination place. However, the conventional navigation system does not provide route information considering other entry points and/or other exit points.

### SUMMARY

The present disclosure relates to a navigation system and a route search method therefor, which can establish database including connection information between entry points and exit points for an object based on positioning data transmitted from vehicles, and perform route search using the connection information between entry points and exit points for the spatial object.

According to an aspect of the present disclosure, a navigation system may comprise: a communication device configured to perform data communication; a data collecting device configured to collect positioning data of vehicles through the communication device; and a processor configured to establish database including connection information between entry points and exit points for each spatial object based on the positioning data, and perform route search using the connection information between the entry points and the exit points for each spatial object when there is a route search request.

The processor may be configured to the entry points and the exit points for each spatial object using the positioning data.

The processor may be configured to identify a departure exit point associated with a departure entry point used at time of entering a departure place, by referring to the connection information between entry points and exit points for each spatial object in searching for routes.

When there are two or more departure exit points, the processor may be configured to search for a route with respect to each of the departure exit points.

When there are two or more destination entry points in searching for the routes, the processor may be configured to search for a route with respect to each of the destination entry points.

When there are the two or more departure exit points and the two or more destination entry points, the processor may be configured to search for a route from each of the departure exit points to each of the destination entry points.

When there are the two or more departure exit points and one destination entry point, the processor may be configured to search for a route from each of the departure exit points to a destination place.

When there are one departure exit point and the two or more destination entry points, the processor may be configured to search for a route from the departure place to each of the destination entry points.

The processor may select, as an optimal route, any one of found routes in consideration of travel times, travel distances, and traffic situation of the found routes.

When there are one departure exit point and one destination entry point, the processor be configured to search for a route from the departure place to a destination place.

According to another aspect of the present disclosure, a route search method for a navigation system may comprise: collecting positioning data of vehicles; establishing database including connection information between entry points and exit points for each spatial object based on the positioning data, and when there is a route search request; performing route search using the connection information between the entry points and the exit points for each spatial object.

The establishing of the database may include estimating an entry point and an exit point for each spatial object using the collected positioning data.

The performing of the route search may include, when the route search request is received, identifying a departure exit point associated with a departure entry point used at time of entering a departure place by referring to the connection information between the entry points and the exit points for each spatial object, and when there are two or more departure exit points identified, performing route search based on each of the departure exit points.

The performing of the route search based on each of the departure exit points may include, when there are the two or more departure exit points identified, identifying a destination entry point, and when there are two or more destination entry points, searching for a route from each of the departure exit points to each of the destination entry points.

The route search method may further include, when there is one destination entry point in the identifying of the destination entry point, searching for a route from each of the departure exit points to a destination place.

The route search method may further include, after the identifying of the departure exit point associated with the departure entry point, when there is one departure exit point identified, identifying a destination entry point, and when there are two or more destination entry points identified, searching for a route from the departure place to each of the destination entry points.

The route search method may further include, when there is one destination entry point in the identifying of the destination entry point, searching for a route from a departure place to a destination place.

The route search method may further include, after the searching of the route, selecting, as an optimal route, any one of found routes in consideration of travel times, travel distances, and traffic situation of the found routes.

### BRIEF DESCRIPTION OF THE DRAWINGS

The above and other objects, features and advantages of the present disclosure will be more apparent from the following detailed description taken in conjunction with the accompanying drawings:

FIG. 1 is a configuration diagram illustrating a navigation system according to an embodiment of the present disclosure;

FIG. 2 is a diagram for describing a process of generating connection relationship information between entry points and exit points according to an embodiment of the present disclosure;

FIG. 3 is a flowchart of a method for establishing connection information between entry points and exit points for each spatial object according to an embodiment of the present disclosure;

FIGS. 4A and 4B are flowcharts of a route search method for a navigation system according to an embodiment of the present disclosure; and

FIGS. 5 and 6 are diagrams for describing a method of displaying a result of route search according to an embodiment of the present disclosure.

### DETAILED DESCRIPTION

Hereinafter, exemplary embodiments of the present disclosure will be described in detail with reference to the accompanying drawings. It should be noted that in giving reference numerals to elements of each drawing, like reference numerals refer to like elements even though like elements are shown in different drawings. In addition, a detailed description of well-known features or functions will be ruled out in order not to unnecessarily obscure the gist of the present disclosure.

In addition, terms, such as first, second, A, B, (a), (b) or the like may be used herein when describing components of the present disclosure. Each of these terminologies is not used to define an essence, order or sequence of a corresponding component but used merely to distinguish the corresponding component from other component(s). Although not differently defined, entire terms including a technical term and a scientific term used here have the same meaning as a meaning that may be generally understood by a person of common skill in the art. It is additionally analyzed that terms defined in a generally used dictionary have a meaning corresponding to a related technology document and presently disclosed contents and are not analyzed as an ideal or very official meaning unless stated otherwise.

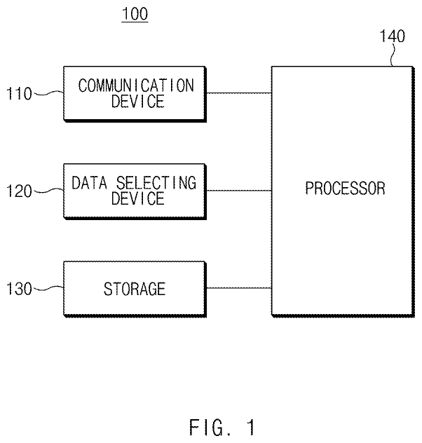

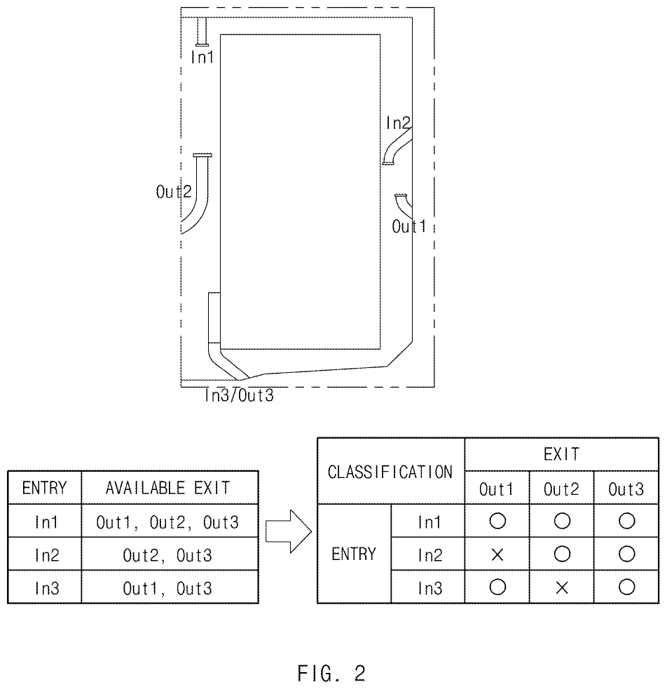

FIG. 1 is a configuration diagram illustrating a navigation system according to an embodiment of the present disclosure, and FIG. 2 is a diagram for describing a process of generating connection information between entry points and exit points according to an embodiment of the present disclosure.

Referring to FIG. 1, a navigation system 100 may include a communication device 110, a data collecting device 120, storage 130, and a processor 140.

The communication device 110 may perform wired and/or wireless communication with a vehicle, a roadside unit, and/or a traffic information providing system, or the like. As wired communication technology, Local Area Network (LAN), Wide Area Network (WAN), Ethernet, Integrated Services Digital Network (ISDN) and/or the like may be used, and as wireless communication technology, wireless Internet, mobile communication and/or the like may be used. Herein as wireless Internet technology, telematics, WLAN (Wireless LAN) (WiFi), Wibro (Wireless broadband), Wimax (World Interoperability for Microwave Access), and the like may be used. As mobile communication technology, CDMA (Code Division Multiple Access), GSM (Global System for Mobile communication), LTE (Long Term Evolution), LTE-Advanced and the like may be used.

The data collecting device 120 may collect positioning data (positioning information) transmitted from vehicles through the communication device 110. The positioning data refers to vehicle position information measured by a positioning apparatus mounted on a vehicle and may include vehicle identification information, coordinates information and/or time information. The data collecting device 120 may collect the positioning data at predefined periods. The data collecting device 120 may store the collected positioning data in the storage 130. In various exemplary embodiments of the present disclosure, the data collecting device 120 may be a processor such as a CPU, separate from the processor 140, configured to be programmed to perform specific functions, or may be embedded in the processor 140.

The storage 130 may store programs for operation of the processor 140 and temporarily store input/output data. The storage 130 may be implemented with at least one storage medium (recording medium) of storage media including flash memory, hard disk, Secure Digital (SD) Cards, Random Access Memory (RAM), Static Random Access Memory (SRAM), Read Only Memory (ROM), Programmable Read Only Memory (PROM), Electrically Erasable and Programmable ROM (EEPROM), Erasable and Programmable ROM (EPROM), a register, a removable disk and web storage.

The storage 130 may store a route search algorithm and may store map information, road information, and connection information between entry points and exit points for each spatial object, in the form of database. The storage 130 may temporarily store the positioning data collected by the data collecting device 120.

The processor 140 may control overall operation of the navigation system. The processor 140 may include at least one of Application Specific Integrated Circuits (ASIC), Digital Signal Processors (DSP), Programmable Logic Devices (PLD), Field Programmable Gate Arrays (FPGAs), Central Processing units (CPU), microcontrollers, and microprocessors.

The processor 140 may estimate an entry point and an exit point for each spatial object based on the positioning data collected by the data collecting device 120. The spatial object is a point of interest (POI) of a predetermined size and examples thereof may include a department store, a performance hall, a stadium and a shopping mall. The processor 140 may determine whether a vehicle exits a road to enter the spatial object or whether a vehicle enters a road to exit the spatial object, by mapping the positioning data to map information. The processor 140 may determine a road exit point of the vehicle as an entry point (an entrance gate) of the spatial object. On the other hand, the processor 140 may determine a road entry point of the vehicle as an exit point (an exit gate) of the spatial object. In other words, when a plurality of vehicles deviate from a road around the spatial object during driving, the processor 140 may collect pieces of position information of places in which the plurality of vehicles have deviated from the road, and when the pieces of position information collected are identical to each other, determine a corresponding place as an entry point of the spatial object. On the other hand, the processor 140 may collect pieces of position information of places in which a plurality of vehicles enter a road, from the plurality of vehicles which have entered the road from the spatial object and, when the pieces of position information collected are identical to each other, determine a corresponding place as an exit point of the spatial object.

For example, when a plurality of vehicles of vehicles which are traveling on a road “A” deviate from the road “A” in the direction of the spatial object in a certain place of the road “A”, the processor 140 may determine the certain place as an entry point of the spatial object. In addition, when a plurality of vehicles enter the road “A” from the spatial object in another place of the road A, the processor 140 may determine the another place as an exit point of the spatial object.

The processor 140 may identify an entry point used when a vehicle enters the spatial object and an exit point used when the vehicle exits the spatial object, based on the collected positioning data. In other words, the processor 140 may identify at which exit point a vehicle is capable of exiting the spatial object for each entry point of the spatial object.

The processor 140 may establish database by arranging connection relationship (connection information) between entry points and exit points for each spatial object based on information on at which exit point a vehicle is capable of exiting the spatial object for each entry point.

For example, as illustrated in FIG. 2, in a case in which there are three entrance gates (entry points) and three exit gates (exit points) in an underground parking lot, that is a spatial object, the processor 140 may collect information on at which exit point a vehicle is capable of exiting the spatial object with respect to each entry point by using positioning data transmitted from vehicles which have entered and exited the spatial object. When a vehicle is capable of exiting a spatial object at exit points Out1, Out2, and Out3 in the case of entering the spatial object at an entry point In1, the vehicle is capable of exiting the spatial object at the exit points Out2 and Out3 in the case of entering the spatial object at an entry point In2, the vehicle is capable of exiting the spatial object at the exit points Out1 and Out3 in the case of entering the spatial object at an entry point In3, according to the collected information, the processor 140 may establish kind of database by arranging connection information between the entry points and the exit points as in FIG. 2.

The processor 140 may apply the connection information between the entry points and the exit points for each spatial object to map information. Thereafter, the processor 140 may perform route search by using the map information including the connection information between the entry points and the exit points for each spatial object.

A process of performing route search in the processor 140 will be described in detail below.

The processor 140 may receive a route search request transmitted from an electronic device (for example, a navigation terminal, a smart phone, or a tablet) positioned in a vehicle. The processor 140 may identify at least one exit point of a departure place and at least one entry point of a destination place by mapping information on the departure place and the destination place included in the route search request onto map information. When identifying the exit point in the departure place, the processor 140 may identify the exit point associated with an entry point used at the time of entering the departure place by referring to connection information between entry points and exit points for each spatial object.

For example, in a case in which there are three entrance gates and three exit gates in a certain spatial object as illustrated in FIG. 2, when a vehicle enters the spatial object through an entrance gate In2, the processor 140 may determine, as exit points for the departure place of the spatial object, exit gates Out2 and Out3 by referring to connection information between the entry points and the exit points of the spatial object although there are three exit gates in the spatial object. That is, the processor 140 may select an exit point at which a vehicle is capable of exiting a spatial object based on an entry point used in the case of entering the spatial object.

When there are two or more identified exit points for the departure place, the processor 140 may perform route search based on each of the identified exit points for the departure place. In other words, when there is a plurality of exit points in a departure place, the processor 140 may set a position of each of the exit points in the departure place as a starting position and search for a route.

In addition, the processor 140 may identify the number and positions of destination-entry points (entry points in a destination place). When there are two or more destination entry points, the processor 140 may perform route search based on each of the destination entry points.

When there are two or more departure exit points and two or more destination entry points, the processor 140 may search routes from each of the departure exit points to each of the destination entry points. For example, when two exit points “A” and “B” are present in a departure place and three entry points “C”, “D”, and “E” are present in a destination place, the processor 140 may search for total six routes: a route from point “A” to point “C”, a route from point “A” to point “D”, a route from point “A” to point “E”, a route from point “B” to point “C”, a route from point B to point “D”, and a route from point “B” to point “E”.

When there are two or more departure exit points and a single destination entry point, the processor 140 may search routes from each of the departure exit points to the destination entry point (destination place). For example, when there are three departure exit points, the processor 140 may search for three routes from each of the departure exit points to the destination entry point.

When there are a single departure exit point and two or more destination entry points, the processor 140 may search routes from the departure exit point to each of the destination entry points. For example, when there are a single departure exit point and three destination entry points “A”, “B”, and “C”, the processor 140 may search for a route from departure exit point to the destination entry point “A”, a route from departure exit point to the destination entry point “B”, and a route from departure exit point to the destination entry point “C”.

When there are a single departure exit point and a single destination entry point, the processor 140 may search for a route from a departure place to a destination place in the same manner as a conventional route search manner.

Thereafter, the processor 140 may select any one of found routes as an optimal route in consideration of travel times, a travel distance, traffic situation and the like of the found routes. When a single route is found, the processor 140 may provide the found route as an optimal route.

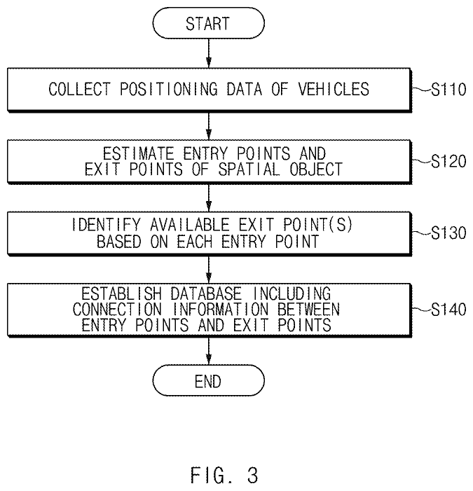

FIG. 3 is a flowchart of a method for establishing connection information between entry points and exit points for each spatial object according to an embodiment of the present disclosure.

Referring to FIG. 3, the processor 140 of the navigation system 100 may collect positioning data of vehicles (S110). The processor 140 may collect vehicle position information measured by positioning devices positioned in the vehicle at predetermined periods, through the data collecting device 120.

The processor 140 may estimate an entry point and an exit point of a spatial object based on the collected positioning data. When a plurality of vehicles exit from a road at a certain point of the road, the processor 140 may determine a corresponding exiting point as an entry point through the positioning data. When a plurality of vehicles enters a road at a certain point of the road, the processor 140 may determine a corresponding entering point as an exit point through the positioning data.

The processor 140 may identify (analyze) an entry point-based available exit point (S130). The processor 140 may identify available exit points for each entry point in a spatial object by checking an entry point used when a vehicle enters the spatial object and an exit point used when the vehicle exits from the spatial object.

The processor 140 may establish database including connection information between entry points and exit points (S140). The processor 140 may establish database including connection information between entry points and exit points for each spatial object and store the database in the storage 130.

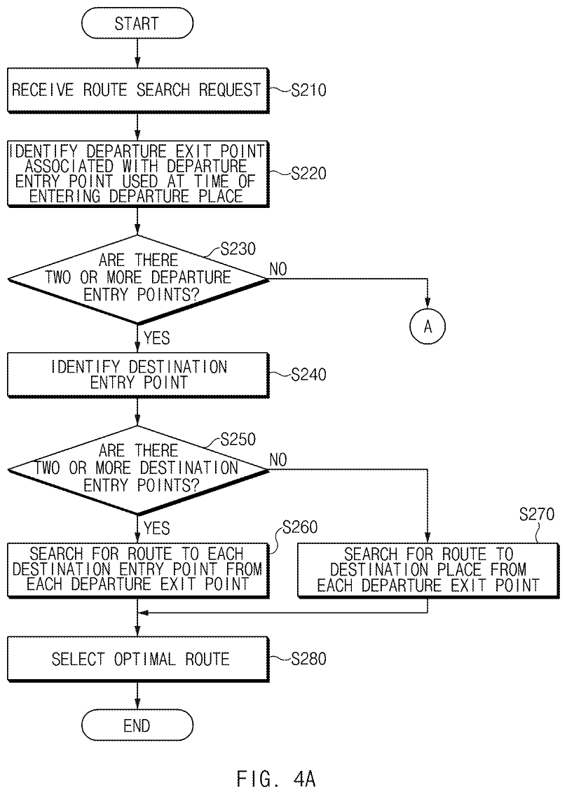

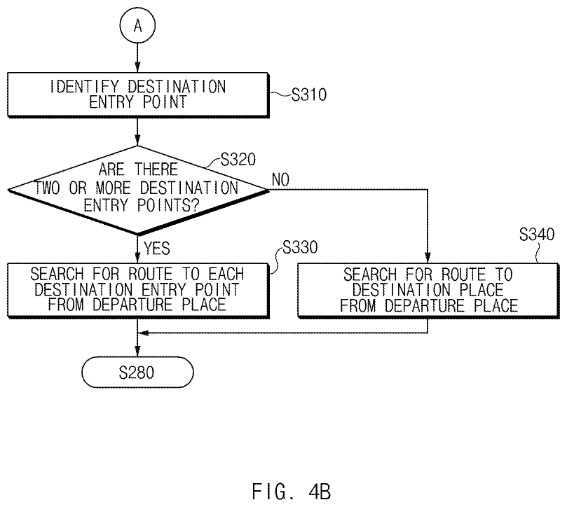

FIGS. 4A and 4B are flowcharts of a route search method for a navigation system according to an embodiment of the present disclosure.

The processor 140 of the navigation system 100 may receive a route search request through the communication device 110 (S210). The route search request may be transmitted from an electronic device (for example, a navigation terminal, a smart-phone, or the like) positioned in a vehicle.

The processor 140 may identify a departure exit point associated with a departure entry point used at the time of entering a departure place (S220). In this case, the processor 140 may identify the departure exit point associated with a departure entry point by referring to connection information between entry points and exit points for each spatial object, which is stored in the storage 130. In addition, the processor 140 may identify the number and positions of departure exit points by using the connection information between the entry points and the exit points for each spatial object, and map information.

The processor 140 may identify whether the number of the identified departure exit points is two or more (S230). When a specific entry point is used at the time of entering a spatial object, the processor 140 may identify whether there are a plurality of available exit points in the spatial object in the case of entry at the specific entry point.

When there are two or more departure exit points, the processor 140 may identify destination entry points (S240). In this case, the processor 140 may identify the number and positions of destination entry points by using the connection information between the entry points and the exit points for each spatial object, and map information.

The processor 140 may identify whether the number of the identified destination entry points is two or more (S250). The processor 140 may identify whether there is a plurality of available entrance gates in the case of entering a spatial object mapped to a destination place.

The processor 140 may search for routes to each of the destination entry points for each of the departure exit points (S260). In other words, the processor 140 may search for routes from each departure exit point to each destination entry point. For example, when there are three departure exit points and three destination entry points, the processor 140 may search for nine routes.

When it is identified that a single entry point is present in a destination place in step S250, the processor 140 may search for routes from each of the departure exit points to the destination place (S270). In other words, the processor 140 searches for routes from each of the departure exit points to the destination.

The processor 140 may select any one of the found routes as an optimal route (S280). In this case, the processor 140 may select an optimal route in consideration of travel times, travel distances, traffic situation, and the like of the found routes.

When it is identified that a single departure exit point is present in a departure place in step S230, the processor 140 may identify the destination entry point (S310). In this case, the processor 140 may identify the number and positions of destination entry points by using the connection information between the entry points and the exit points for each spatial object, and map information.

The processor 140 may identify whether the number of destination entry points is two or more (S320). The processor 140 may identify whether there are a plurality of available entry gates in the case of entering a spatial object mapped to a destination place.

When there are two or more destination entry points, the processor 140 may search routes from the departure place to each of the destination entry points. Thereafter, the processor 140 may select any one of the found routes as an optimal route (S280). In this case, the processor 140 may select an optimal route in consideration of a travel time, a travel distance, traffic situation and the like.

When it is identified that a single entry point is present in a destination place in step S320, the processor 140 may search for routes from the departure place to the destination place (S340). The processor 140 may provide the found route as an optimal route.

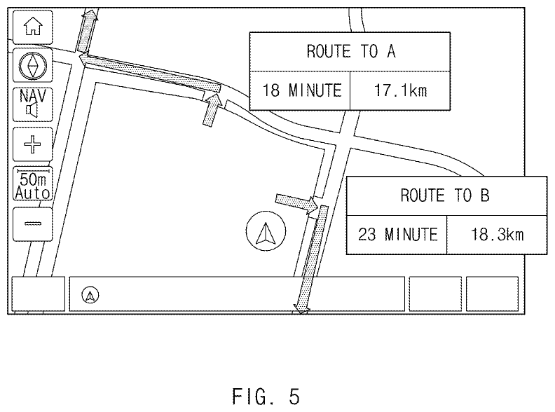

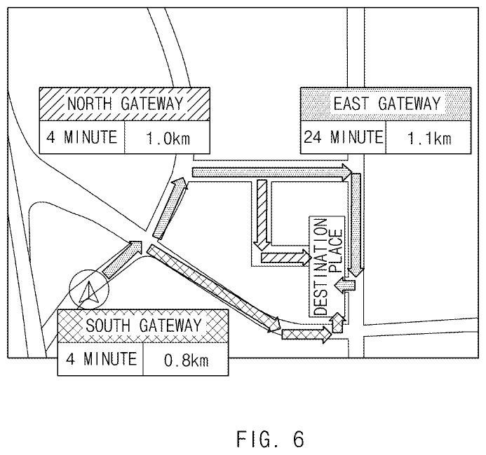

FIGS. 5 and 6 are diagrams for describing a method for displaying a result of route search according to an embodiment of the present disclosure.

A navigation terminal (for example, telematics terminal or smart phone) positioned within a vehicle may receive a result of route search from the navigation system 100 and display the result of route search on a display screen. When two exit points are positioned in a departure place, the navigation system 100 may search for and provide routes with respect to each of the exit points. As illustrated in FIG. 5, a navigation terminal may display information on routes found with respect to each exit point.

In addition, when three entry points are positioned in a destination place as illustrated in FIG. 6, the navigation system 100 may search for routes with respect to each of the entry points. That is, the navigation system 100 may search for a route for entering a north gateway of the destination place, a route for entering an east gateway of the destination place, and a route for entering a south gateway of the destination place. The navigation system 100 may provide the found routes to a navigation terminal and the navigation terminal may display information on each of the found routes. Thereafter, when a user selects any one of the entry points, the navigation terminal may provide a guide for an exit point connected to the selected entry point based on connection information between entry points and exit points of a spatial object, which is mapped to a destination place provided from the navigation system 100.

According to the present disclosure, it is possible to establish database including connection information between entry points and exit points for each spatial object based on the positioning data transmitted from vehicles and perform route search using the connection information between entry points and exit points for each spatial object, thereby providing an optimal route in consideration of the connection information between entry points and exit points for each spatial object when there are a plurality of entry points or exit points in a departure place and/or a destination place.

The foregoing description is merely illustrative of the technical idea of the present disclosure, and various changes and modifications may be made by those skilled in the art without departing from the essential characteristics of the present disclosure. Accordingly, the embodiments disclosed herein are merely illustrative and are not intended to limit the technical concept of the present disclosure, and the scope of the technical idea of the present disclosure is not limited to the embodiments. The scope of protection of the disclosure is to be interpreted by the following claims, all spirits within a scope equivalent will be construed as included in the scope of the present disclosure.

What is claimed is:

1. A navigation system comprising:
a communication device configured to perform data communication;
a data collecting device configured to collect positioning data of vehicles through the communication device; and
a processor configured to:
establish database including connection information between entry points and exit points for each spatial object based on the positioning data; and
when there is a route search request, perform route search using the connection information.

2. The navigation system of claim 1, wherein the processor is configured to estimate the entry points and the exit points for each spatial object using the positioning data.

3. The navigation system of claim 1, wherein the processor is configured to identify a departure exit point associated with a departure entry point used at time of entering a departure place, by referring to the connection information between the entry points and the exit points for each spatial object in searching for routes.

4. The navigation system of claim 3, wherein, when there are two or more departure exit points, the processor is configured to search for a route with respect to each of the two or more departure exit points.

5. The navigation system of claim 4, wherein, when there are two or more destination entry points in searching for the routes, the processor is configured to search for a route with respect to each of the two or more destination entry points.

6. The navigation system of claim 5, wherein, when there are the two or more departure exit points and the two or more destination entry points, the processor is configured to search for a route from each of the two or more departure exit points to each of the two or more destination entry points.

7. The navigation system of claim 5, wherein, when there are the two or more departure exit points and one destination entry point, the processor is configured to search for a route from each of the two or more departure exit points to a destination place.

8. The navigation system of claim 5, wherein, when there are one departure exit point and the two or more destination entry points, the processor is configured to search for a route from the departure place to each of the two or more destination entry points.

9. The navigation system of claim 6, wherein the processor is configured to select, as an optimal route, any one of found routes in consideration of travel times, travel distances, and a traffic situation of the found routes.

10. The navigation system according to claim 5, wherein, when there are one departure exit point and one destination entry point, the processor is configured to search for a route from the departure place to a destination place.

11. A route search method for a navigation system, comprising steps of:
collecting positioning data of vehicles;
establishing database including connection information between entry points and exit points for each spatial object based on the positioning data; and
when there is a route search request, performing route search using the connection information between the entry points and the exit points for each spatial object.

12. The route search method of claim 11, wherein the step of establishing the database includes a step of estimating an entry point and an exit point for each spatial object using the positioning data.

13. The route search method of claim 11, wherein the step of performing the route search includes steps of:
when the route search request is received, identifying a departure exit point associated with a departure entry point used at time of entering a departure place by referring to the connection information; and
when there are two or more departure exit points identified, performing route search based on each of the two or more departure exit points.

14. The route search method of claim 13, wherein the step of performing the route search based on each of the two or more departure exit points includes steps of:
when there are the two or more departure exit points identified, identifying a destination entry point; and
when there are two or more destination entry points, searching for a route from each of the two or more departure exit points to each of the two or more destination entry points.

15. The route search method of claim 14, further comprising a step of, when there is one destination entry point in the step of identifying the destination entry point, searching for a route from each of the two or more departure exit points to a destination place.

16. The route search method of claim 13, further comprising, after the step of identifying of the departure exit point associated with the departure entry point:
when there is one departure exit point identified, identifying a destination entry point, and
when there are two or more destination entry points identified, searching for a route from the departure place to each of the two or more destination entry points.

17. The route search method of claim 16, further comprising, when there is one destination entry point in the identifying of the destination entry point, searching for a route from a departure place to a destination place.

18. The route search method of claim 14, further comprising a step of, after the searching of the route, selecting, as an optimal route, any one of found routes in consideration of travel times, travel distances, and a traffic situation of the found routes.
